(19) United States
(12) Patent Application Publication
(10) Pub. No.: US 2011/0315545 A1
(43) Pub. Date: Dec. 29, 2011

(54) HYDROGEN GENERATING DEVICE

(75) Inventors: Tomohiro Kuroha, Aichi (JP); Takaiki Nomura, Osaka (JP); Takahiro Suzuki, Osaka (JP); Kenichi Tokuhiro, Osaka (JP); Noboru Taniguchi, Osaka (JP); Kazuhito Hatoh, Osaka (JP); Shuzo Tokumitsu, Hyogo (JP)

(73) Assignee: PANASONIC CORPORATION, Kadoma-shi, Osaka (JP)

(21) Appl. No.: 13/254,114

(22) PCT Filed: Apr. 14, 2010
(86) PCT No.: PCT/JP2010/002716

§ 371 Date: Aug. 31, 2011

(30) Foreign Application Priority Data
Apr. 15, 2009 (JP) 2009-098676

(51) Int. Cl. C25B 9/00

(52) U.S. Cl. 204/242

(57) ABSTRACT

A hydrogen generating device (100) includes: a housing (1) that is capable of holding a liquid therein, and that is at least partially transmissive to light; an electrolyte that is held in the housing (1) and that contains water; a photoelectrode (2) that is arranged in the housing (1), that has a first surface in contact with the electrolyte, and that generates gas through decomposition of the water by being irradiated with light transmitted through the housing (1); and a conductor (3) that is arranged in a region on the second surface side opposite to the first surface side with respect to the photoelectrode (2) inside the housing (1), that has a surface in contact with the electrolyte, and that is connected electrically with the photoelectrode (2). The conductor (3) has a groove portion (3a) that is provided on the surface in contact with the electrolyte, and that extends along the flow direction of the generated gas.

### TECHNICAL FIELD

The present invention relates to a hydrogen generating device that includes a photoelectrode having an optical semiconductor, and that generates hydrogen through water decomposition by irradiation of the photoelectrode with light such as sunlight.

### BACKGROUND ART

There is a conventionally known method for obtaining hydrogen and oxygen through water decomposition by irradiation of an optical semiconductor material that functions as a photocatalyst with light (see Patent Literature 1, for example).

Further, there also is a device in which the light absorption area is increased by forming roughness on an optical semiconductor itself, so that the light use efficiency is enhanced, thereby allowing the hydrogen production efficiency to be improved (see Patent Literature 2, for example).

### CITATION LIST

### Patent Literature

Patent Literature 1: JP 4 (1992)-231301 A
Patent Literature 2: JP 2007-45645 A

### SUMMARY OF INVENTION

### Technical Problem

However, in the case of employing a structure, for example, as Patent Literature 1, in which an optical semiconductor (optical semiconductor electrode) is provided on the outer surface of a cylindrical conductor while a counter electrode is provided on the inner surface thereof so that hydrogen and oxygen generated inside and outside the cylinder are separated from each other, these electrodes are required to be arranged perpendicular to sunlight when using sunlight. In this case, if the surface of the optical semiconductor electrode is arranged to face the sunlight, hydrogen or oxygen generated on the surface of the counter electrode inside the cylinder covers the surface of the counter electrode and is made unlikely to be released therefrom, though hydrogen or oxygen generated on the surface of the optical semiconductor electrode would be released from the surface of the optical semiconductor electrode. Therefore, such a configuration has a problem that the contact area between water and the counter electrode decreases, and thus the gas production efficiency decreases.

The same problem occurs not only in the case of using a cylindrical electrode unit, but also in the case of using a flat electrode unit, where an electrode (photoelectrode) having an optical semiconductor and a counter electrode are provided respectively on the front and back sides so as to form an integrated structure. In this case, the device is positioned so that the photoelectrode surface should be irradiated with light. The gas generated on the counter electrode surface that does not receive the light is released, moving along the counter electrode surface. Therefore, this configuration also has the problem that the contact area between water and the counter electrode decreases, and thus the gas production efficiency decreases.

As Patent Literature 2, for example, an improvement can be expected in the gas production efficiency of the photoelectrode that receives the light by forming convex and concave portions on the optical semiconductor itself for the purpose of increasing the light use efficiency. However, if simple convex and concave portions, a simple porous structure, etc., are formed on the counter electrode, in the same manner as on the photoelectrode, in consideration of the improvement of the light use efficiency, there is a problem, in the case of employing an integrated structure by providing the photoelectrode and the counter electrode respectively on the front and back sides, that the generated gas accumulates in the concave portions on the counter electrode, and the contact area between water and the counter electrode decreases, resulting in a decrease in the gas production efficiency.

The present invention solves the aforementioned conventional problems, and it is therefore an object of the present invention to suppress the decrease in the contact area between the counter electrode and water due to the generated gas, thereby improving the hydrogen production efficiency in the hydrogen generating device that generates hydrogen through water decomposition by irradiation of the photoelectrode with light.

### Solution to Problem

In order to solve the conventional problems, the hydrogen generating device of the present invention includes: a housing that is capable of holding a liquid therein, and that is at least partially transmissive to light; an electrolyte that is held in the housing, and that contains water; a photoelectrode that is arranged in the housing, that has a first surface in contact with the electrolyte, and that generates gas through decomposition of the water by being irradiated with light transmitted through the housing; and a conductor that is arranged in a region on a second surface side opposite to the first surface side with respect to the photoelectrode inside the housing, that has a surface in contact with the electrolyte, and that is connected electrically with the photoelectrode. The conductor has a groove portion that is provided on the surface in contact with the electrolyte, and that extends along the flow direction of the generated gas.

### Advantageous Effects of Invention

Generally, in order to enhance the light use efficiency, a hydrogen generating device is positioned in a direction that allows the surface of a photoelectrode in contact with an electrolyte to face light such as sunlight. When the hydrogen generating device of the present invention is positioned in such a way, a conductor that functions as a counter electrode is arranged with the surface in contact with the electrolyte being oriented downward. In the hydrogen generating device of the present invention, the conductor has a groove portion that is provided on the surface in contact with the electrolyte, and that extends along the flow direction of the generated gas. Therefore, this groove portion functions as a guide path for the gas. Accordingly, the gas generated from the surface of the conductor in contact with the electrolyte is collected into the groove portion due to buoyancy, and then moves upward along the groove portion. Thus, as compared to the configuration without a groove portion, the conductor is rendered less likely to be covered by the generated gas. This suppresses the decrease in the contact area between the conductor and water, thereby allowing the hydrogen production efficiency to be improved. It should be noted that the terms, upward and downward, herein correspond respectively to upward and downward in the direction in which the gas in the liquid moves due to buoyancy, that is, in the vertical direction.

### BRIEF DESCRIPTION OF DRAWINGS

FIG. 1 is a perspective illustration showing a hydrogen generating device of Embodiment 1 of the present invention.

FIG. 2 is a schematic illustration showing the hydrogen generating device of Embodiment 1 of the present invention as viewed from a lateral side thereof.

FIG. 3 is a perspective illustration showing a conductor in the hydrogen generating device of Embodiment 1 of the present invention.

FIG. 4 is a perspective illustration showing a conductor in a hydrogen generating device of Embodiment 2 of the present invention.

FIG. 5 is a view showing the surface shape of a conductor in a hydrogen generating device of Embodiment 3 of the present invention.

### DESCRIPTION OF EMBODIMENTS

Hereinafter, the embodiments of the present invention are described with reference to the drawings. The following embodiments are described as an example, and the present invention is not limited to these embodiments. Furthermore, in the following embodiments, the same parts are denoted by the same numerals, and overlapping descriptions may be omitted.

### Embodiment 1

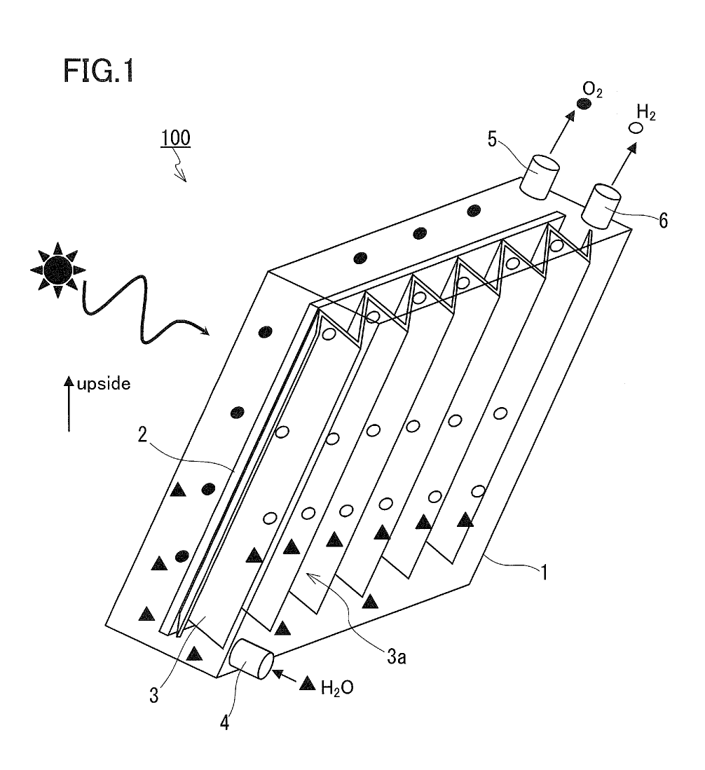

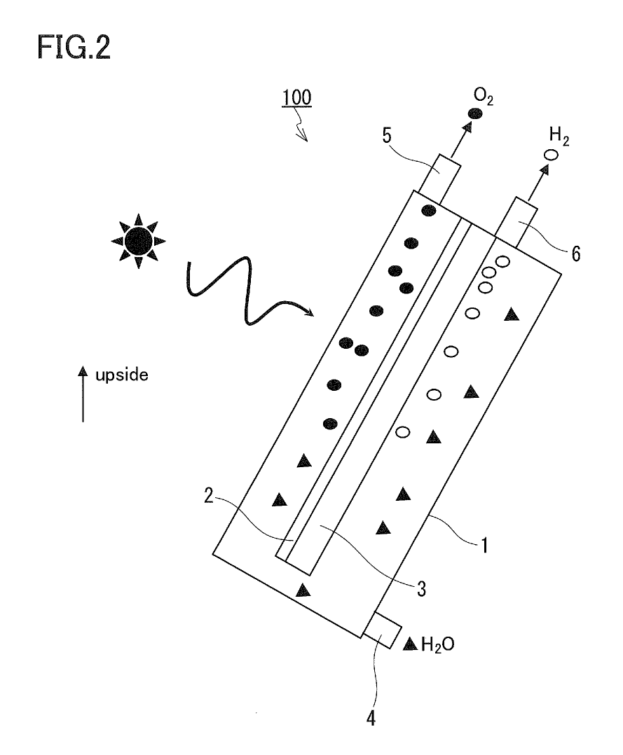

FIG. 1 is a perspective illustration showing a hydrogen generating device 100 of Embodiment 1 of the present invention. FIG. 2 is a schematic illustration showing the hydrogen generating device 100 as viewed from a lateral side thereof. FIG. 1 and FIG. 2 show the case of using sunlight. In this case, the hydrogen generating device 100 is positioned, in consideration of the light use efficiency, at an angle with respect to the horizontal so that a photoelectrode 2 faces the sunlight.

As shown in FIG. 1 and FIG. 2, in the hydrogen generating device 100 of this embodiment, the photoelectrode 2 that includes at least an optical semiconductor, and a conductor 3 that is provided in contact with the photoelectrode 2 are provided in a housing 1. In this embodiment, the hydrogen generating device 100 is positioned so that the surface (a first surface, which is hereinafter referred to as a “front surface”, for convenience of description) of the photoelectrode 2 opposite to the surface (a second surface, which is hereinafter referred to as a “back surface”, for convenience of description) thereof in contact with the conductor 3 faces upward. Accordingly, the hydrogen generating device 100 is positioned so that the surface (which is hereinafter referred to as a “front surface”, for convenience of description) of the conductor 3 opposite to the surface (which is hereinafter referred to as a “back surface”, for convenience of description) thereof in contact with the photoelectrode 2 faces downward. It should be noted that the terms, upward and downward, herein correspond respectively to upward and downward in the vertical direction. Accordingly, the phrase “the front surface of the photoelectrode 2 faces upward” means that the front surface of the photoelectrode 2 faces toward the region including the vertically upward direction with respect to the horizontal, and the phrase “the front surface of the conductor 3 faces downward” means that the front surface of the conductor 3 faces toward the region including the vertically downward direction with respect to the horizontal.

The housing 1 is provided with an inlet 4 for water, and the inside of the housing 1 is filled with water supplied through the inlet 4. The front surface of the photoelectrode 2 and the front surface of the conductor 3 each are in contact with the water. In this embodiment, water alone is used as an electrolyte containing water. However, as such an electrolyte, it also is possible to use an aqueous solution obtained by dissolving an electrolyte, etc., in water.

Further, the housing 1 is provided with gas outlets 5 and 6 for discharging the gas generated therein to the outside. The generated gas moves upward inside the housing due to buoyancy. Therefore, in order to collect the generated gas efficiently, the gas outlets 5 and 6 are provided at positions that serve as the upper part of the housing 1 in the state where the hydrogen generating device 100 is set in place. In this embodiment, since an n-type semiconductor is used as the optical semiconductor of the photoelectrode 2, oxygen is generated from the front surface of the photoelectrode 2 while hydrogen is generated from the front surface of the conductor 3 that functions as a counter electrode. Accordingly, oxygen is discharged through the gas outlet 5 that is arranged in the region on the photoelectrode 2 side in the housing 1, and hydrogen is discharged through the gas outlet 6 that is arranged in the region on the conductor 3 side therein.

The hydrogen generating device 100 is irradiated with light that is suitable for the optical semiconductor used for the photoelectrode 2 (light that excites the optical semiconductor), such as sunlight, from the side that faces the front surface of the photoelectrode 2. Therefore, in the housing 1, the portion that faces the photoelectrode 2 is made of a material that allows the light that is suitable for the optical semiconductor to be transmitted therethrough. In order to enhance the light use efficiency further, it is preferable that the irradiation with the light be performed so that rays are perpendicular to the front surface of the photoelectrode 2.

Next, the photoelectrode 2 and the conductor 3 are described in more detail.

The photoelectrode 2 is in the form of a plate, and the surface thereof may be flat, or convex and concave portions may be provided on the surface, in order to increase the light absorption area. The photoelectrode 2 needs only to include an optical semiconductor. The photoelectrode 2 may be formed only of the optical semiconductor, or may include other components, for example, by combining a layer made of an optical semiconductor (optical semiconductor layer) and another layer for supporting this. In the case of combining the optical semiconductor with other components, a preferable arrangement is such that the optical semiconductor is exposed on the front surface of the photoelectrode 2 so that the optical semiconductor should be efficiently irradiated with the light.

The material of the optical semiconductor needs to have a band gap of at least 1.23 eV to allow the decomposition of water, as well as having the conduction band that has the bottom level higher than the hydrogen generating level, and having the valence band that has the upper level lower than the oxygen generating level. Examples of such a material include TiO₂, TaON, and Ta₃N₅.

Further, while the optical semiconductor in the photoelectrode 2 is required to have an enough thickness so as to be capable of absorbing the light, an excessive thickness thereof increases the probability of recombination between a hole and an electron generated due to the optical absorption, which is a problem. Therefore, it seems to be favorable that the optical semiconductor layer has a thickness of about several nm to several μm. However, the optimal thickness probably depends on the crystal defects of the photoelectrode 2 or the material thereof, and therefore it is desirable that an appropriate thickness should be selected corresponding to the optical semiconductor to be used.

The optical semiconductor layer of the photoelectrode 2 can be formed using various techniques such as sputtering, evaporation, and spin coating. There is no limitation on the film forming method.

In this embodiment, although an n-type semiconductor is used as the optical semiconductor of the photoelectrode 2, a p-type semiconductor also can be used. In that case, hydrogen is generated from the photoelectrode 2, and oxygen is generated from the conductor 3. Thus, hydrogen is discharged through the gas outlet 5, and oxygen is discharged through the gas outlet 6.

In the configuration in which the optical semiconductor layer of the photoelectrode 2 is supported by another layer, the other layer is in contact with the conductor 3. Accordingly, a metal material is used for the other layer so as not to interrupt the electrical connection between the photoelectrode 2 and the conductor 3. This metal material to be used is desirably a metal material having a high Fermi level so as to form an ohmic contact with the optical semiconductor to be used for the photoelectrode 2. Examples of such a metal material include Ti, Ta, Zr, and Al. Further, it also is possible that the conductor 3 functions as the layer for supporting the optical semiconductor of the photoelectrode 2.

The conductor 3 has a groove portion 3a that is provided on the front surface in contact with water, and that extends along the flow direction of the generated gas. That is, the groove portion 3a is provided so as to extend from the lower side to the upper side in the state where the hydrogen generating device 100 is set in place. In other words, it also can be said that concave portions that are continuous with each other from the lower side to the upper side are provided on the front surface of the conductor 3. In this embodiment, the conductor 3 has a corrugated shape, and the groove portion 3a is formed of a valley portion of the corrugated shape (the valley portion on the front surface of the conductor). The front surface of the conductor 3 faces downward. Thus, the hydrogen generated on the front surface thereof is collected into the groove portion 3a, and moves along the groove portion 3a from the lower side to the upper side. The hydrogen that has moved to the upper side is discharged through the gas outlet 6 into the outside of the housing 1. Such a configuration can prevent the region other than the groove portion 3a on the front surface of the conductor 3 (such as the peak portion of the corrugated shape) from being covered completely by the generated gas. Therefore, it is possible to suppress the decrease, which would be caused by the generated gas, in the contact area between water and the front surface of the conductor 3, thereby improving the hydrogen production efficiency.

In the conductor 3, the depth of the groove portion 3a is desirably at least 100 μm. This is because, when generated bubbles move upward along the front surface of the conductor 3 due to buoyancy, the size of the bubbles increases to such an extent that they can be visually inspected. In addition, the groove portion 3a having a depth of 400 μm or more makes it easy for the bubbles to rise straight, thus making it difficult for the bubbles to grow up. Accordingly, the depth of the groove portion 3a is desirably 400 nm or more. Further, most of the bubbles are triggered to move upward, after the size of the bubbles reaches 1 mm or more. In view of this, the depth of the groove portion 3a is further desirably 1 mm or more. It should be noted that the depth of the groove portion 3a means the maximum value of the height difference on the front surface of the conductor 3. In the case of a corrugated shape, as this embodiment, the height difference between a valley portion and a peak portion corresponds to the depth of the groove portion 3a.

On the other hand, the groove portion 3a having an excessive depth causes problems such as: that the thickness of the conductor 3 itself increases, resulting in an increase in the thickness of the hydrogen generating device 100; and that, in the case where convex and concave portions appear on the front surface of the photoelectrode 2 because of the groove portion 3a of the conductor 3, the convex portions may make shadows on the concave portions in the photoelectrode 2, depending on the incident angle of sunlight. Particularly, the increase in the thickness of the device leads to an increase in the amount of water to be supplied to the device, resulting in an increase in the weight of the device as a whole.

Supposing that the hydrogen generating device 100 is mounted on a standard roof having a mounting area of 22 m², an increase of 1 cm in the thickness would cause an increase of 220 kg in the weight of water. Considering the problem of the weight on the basis of this supposition, the hydrogen generating device 100 is preferably thinner. Solar cells aligned with the mounting area of 22 m² weighs about 300 kg. In view of this, it is estimated that the thickness of the hydrogen generating device 100 is about 2 cm at most, and is more preferably 1 cm or less.

In consideration of these conditions, the depth of the groove portion is preferably at least 100 μm but not more than 2 cm, more preferably 400 μm to 1 cm.

Generally, a metal is used for the conductor 3. However, it also is possible to use a conductive film substrate that include a conductive film, such as ITO (Indium Tin Oxide) and FTO (Fluorine doped Tin Oxide), formed on an insulation substrate such as glass. In the case where the conductor 3 is formed of a metal, Ti, Ta, Zr, and Al, for example, are suitably used because they form an ohmic contact at the junction with the photoelectrode 2.

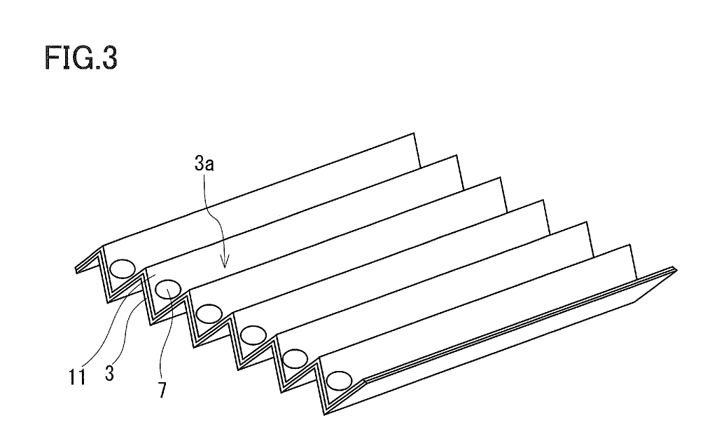

Although not necessary for the conductor 3 having a sufficient water-splitting activity, it is preferable that the conductor 3 support a co-catalyst on the surface (front surface) opposite to the surface in contact with the photoelectrode 2 in order to enhance the hydrogen production efficiency. FIG. 3 shows an embodiment in which the conductor 3 supports a co-catalyst on its entire front surface (an embodiment in which a film 11 composed of co-catalyst is provided on the front surface of the conductor 3), as an example of the embodiment of the conductor 3 supporting a co-catalyst on the front surface. In this figure, 7 denotes the gas generated on the conductor 3 side, and the gas 7 moves along the groove portion 3a. In the configuration in which hydrogen is generated on the conductor 3, the co-catalyst preferably includes at least one selected from Pt, Pd, Rh, Ir, Ru, Os, Au, and Ag that have a low overvoltage for hydrogen generation. In the configuration in which oxygen is generated on the conductor 3, the co-catalyst preferably includes at least one selected from Cu, Ni, Fe, Co, and Mn.

Further, the groove portion 3a may have a hydrophobic coating. This promotes the movement of the generated gas into the groove portion 3a, so that the region other than the groove portion 3a is rendered still less likely to be covered by the generated gas. Therefore, the contact between the conductor 3 and water is not interrupted by the gas in the region other than the groove portion 3a, and thus the hydrogen production efficiency is further improved. Further, the conductor 3 has a higher chance to contact water in the region other than the groove portion 3a. Therefore, the covering of the co-catalyst by the generated gas can be reduced when the region other than the groove portion 3a serves as a region to support the co-catalyst. As a result, the co-catalyst can be used effectively. Moreover, the amount of use of the co-catalyst also can be reduced, which is advantageous in cost even when an expensive co-catalyst is used.

Next, operations in the hydrogen generating device 100 are schematically described. The water introduced into the housing 1 through the inlet 4 is decomposed by the optical semiconductor that is photoexcited through irradiation of the photoelectrode 2 with light. In the case where the optical semiconductor of the photoelectrode 2 is an n-type semiconductor, oxygen is generated on the front surface of the photoelectrode 2. The oxygen generated on the front surface of the photoelectrode 2 moves upward in the housing 1 due to buoyancy, and discharged through the gas outlet 5 provided in the upper part of the housing 1. Simultaneously, hydrogen is generated on the conductor 3 connected electrically with the photoelectrode 2. The hydrogen is collected into the groove portion 3a, and moves from the lower side to the upper side along the groove portion 3a. The hydrogen that has moved upward is discharged through the gas outlet 6 provided in the upper part of the housing 1.

In this embodiment, the conductor 3 having a corrugated shape is used, and the groove portion 3a is formed of the valley portion of the corrugated shape. Therefore, the groove portion 3a has a shape linearly extending along the flow direction of the generated gas. However, the shape of the groove portion in the present invention is not limited thereto. The groove portion may extend in a direction almost along the flow direction of the generated gas, when viewed as a whole, and thus may extend in a curved line. Further, the groove portion desirably extends in a direction in parallel with the flow direction of the generated gas. However, even if the groove portion does not extend in parallel therewith, the gas is guided by the groove portion to move smoothly to the upper part, as long as the groove portion extends in a direction almost along the flow direction of the gas. Thus, no problem occurs. Further, the conductor having a corrugated shape is used in this embodiment. However, the conductor is not limited thereto. The conductor may have a configuration in which a groove portion is provided on the front surface of the conductor, and the back surface thereof in contact with the photoelectrode is flat. Furthermore, it also is possible to improve the hydrogen production efficiency by providing a projection in the region other than the groove portion so as to form a region that is still less likely to be covered by the generated gas. In this way, various changes also can be made in the shape of the conductor for the region other than the groove portion.

Further, although the conductor 3 is provided in contact with the back surface of the photoelectrode 2 in this embodiment, the configuration is not limited to this. The conductor 3 needs only to be arranged in a region on the back surface side of the photoelectrode 2 inside the housing 1, and to be connected electrically with the photoelectrode. Thus, it also is possible to employ a configuration, for example, in which a separator, or the like, is provided between the photoelectrode 2 and the conductor 3, and the photoelectrode 2 and the conductor 3 are connected electrically with each other via a conducting wire, etc.

### Embodiment 2

The hydrogen generating device in Embodiment 2 of the present invention is described. The hydrogen generating device of this embodiment has the same configuration as the hydrogen generating device 100 of Embodiment 1 except that the co-catalyst supported on the conductor is formed at a different position. Accordingly, only the position where the co-catalyst is formed is described herein.

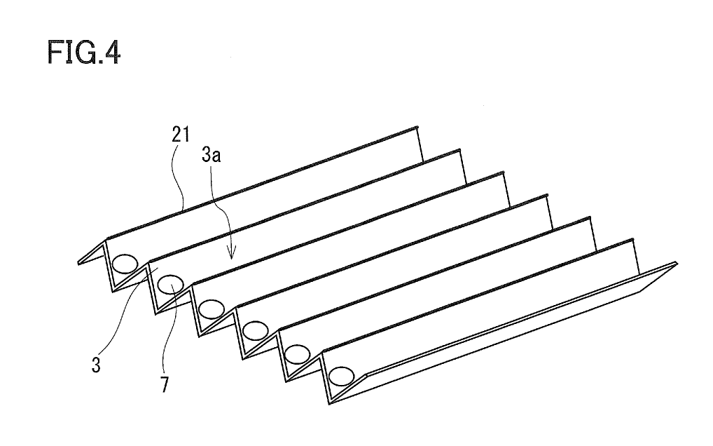

FIG. 4 shows a state in which a co-catalyst 21 is supported on the front surface of the conductor 3. In this embodiment, the co-catalyst 21 is provided in a part of the region other than the groove portion 3a on the front surface of the conductor 3, which herein is the peaks of the corrugated shape. That is, the co-catalyst 21 is provided at the highest position of the conductor 3 with respect to the groove portion 3a.

In this configuration, the co-catalyst 21 is provided at a portion that is less likely to be covered by the generated gas. Therefore, the amount of the co-catalyst 21 can be reduced, while the effect to be brought about by providing the co-catalyst 21 is obtained.

It is desirable that the co-catalyst 21 be provided at the highest position in the region other than the groove portion 3a so that it is less likely to be covered by the gas, which however is not restrictive. The same effect can be obtained as long as the co-catalyst 21 is provided in at least a part of the region other than the groove portion 3a. Moreover, this configuration also is applicable to the case where the conductor 3 does not have a corrugated shape. For example, in the case where a groove that corresponds to the groove portion is formed on a flat surface, the co-catalyst may be provided in a part of the region other than the groove. Alternatively, the co-catalyst may be provided on a projection that is provided in the region other than the groove.

### Embodiment 3

The hydrogen generating device in Embodiment 3 of the present invention is described. The hydrogen generating device of this embodiment has the same configuration as the hydrogen generating device 100 of Embodiment 1 except that the conductor has a different shape and the co-catalyst is formed at a different position. Accordingly, only the shape of the conductor and the position where the co-catalyst is formed are described herein.

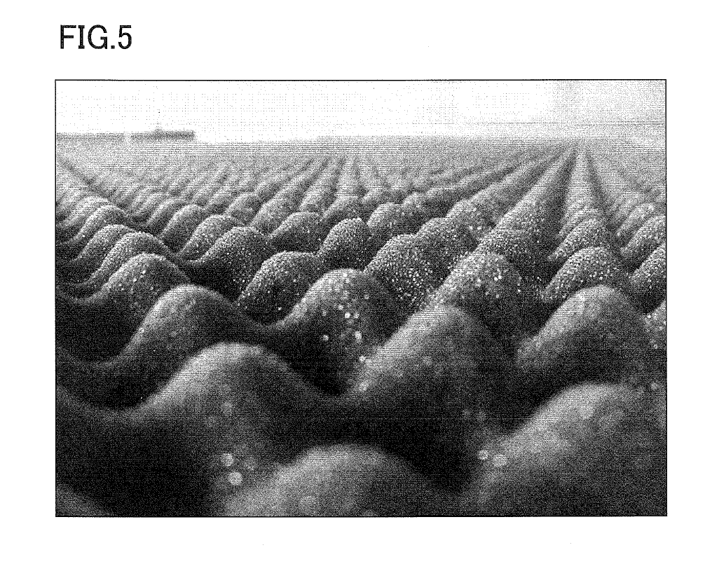

In this embodiment, the front surface of the conductor has a shape in which a plurality of convex and concave portions as shown in FIG. 5 are provided. In this case, the groove portion is formed by the plurality of concave portions being connected to each other so as to be continuous in the flow direction of the gas.

In the case of the conductor having such a shape, the co-catalyst is preferably arranged at the tips of the projecting convex portions. It is possible to reduce the amount of use of the co-catalyst further, as compared to the hydrogen generating devices of Embodiment 1 and 2, by providing the co-catalyst at such a position, which is advantageous in cost even when an expensive co-catalyst is used. Further, when the co-catalyst is provided at the tips of the projecting convex portions, it is possible to reduce the covering of the co-catalyst by the generated gas more surely, so that the co-catalyst can function efficiently.

### EXAMPLES

### Example 1

As Example 1 of the present invention, a hydrogen generating device having the same configuration as the hydrogen generating device 100 of Embodiment 1 was produced. Only the surface on the photoelectrode side of the housing was formed of PYREX (registered trademark) glass, and the other portions thereof were formed of an acrylic resin.

TiO₂ was used for the optical semiconductor of the photoelectrode. A Ti plate was used as a metal material to support the optical semiconductor. First, a Ti plate with a square size of 50 mm×50 mm and a thickness of 0.5 mm was prepared as a metal material to support the optical semiconductor. A TiO₂ film with a thickness of 150 nm was formed on one surface of the Ti metal plate by sputtering. Thus, a photoelectrode was formed.

A 0.5 mm-thick Ti plate was subjected to convex and concave corrugation. Thus, a conductor with a square size of 50 mm×50 mm having a corrugated shape, as shown in FIG. 1 and FIG. 3, was produced. The convex and concave corrugation was carried out so that the height difference between a valley portion and a peak portion in the corrugated shape (the depth of the groove portion) should be 1 mm, and the distance between a valley and a peak adjacent to each other should be 1 mm. A 0.1 μm-thick Pt film was formed, as a film composed of co-catalyst, on the surface that would serve as the front surface of the conductor in the hydrogen generating device set in place, by sputtering. Thus, the conductor that had the groove portion formed by making use of the valley portion of the corrugated shape, and that was provided with the film composed of co-catalyst further on the front surface was obtained. The back surface corresponding to the groove portion of the conductor was joined to the Ti plate of the photoelectrode 2 by spot welding, so that the photoelectrode and the conductor were integrated together. The photoelectrode and the conductor were arranged in the housing so that the groove portion of the conductor extended from the lower side to the upper side in the state where the hydrogen generating device was set in place.

### Comparative Example 1

A hydrogen generating device was produced by the same configuration as Example 1 except that a Ti plate with a square size of 50 mm×50 mm and a thickness of 0.5 mm that had not been subjected to the convex and concave corrugation was used as a conductor.

### Example 2

In Example 1, the film composed of co-catalyst was provided on the entire front surface of the conductor. Meanwhile, in Example 2, a Pt line with a width of 0.01 mm was joined to the conductor along each peak of the corrugated shape by spot welding. Except for this, a hydrogen generating device having the same configuration as Example 1 was produced.

### <Water-Splitting Experiment by Photoirradiation>

A water-splitting experiment by photoirradiation was conducted for each of the hydrogen generating devices of Examples 1 and 2, and Comparative Example 1. The housing was filled with water introduced through the inlet of the housing, and then the hydrogen generating device was irradiated from the side that faced the photoelectrode, with artificial sunlight (XC-100B, manufactured by SERIC LTD.) at a distance of 30 cm. In all the hydrogen generating devices, oxygen bubbles were observed adhering to the front surface of the photoelectrode, and hydrogen bubbles were observed adhering to the front surface of the conductor. In this regard, the size of the bubbles, as observed by visual inspection, was from about 100-μm diameter to about 1-mm diameter in every case.

In the hydrogen generating device of Example 1, the hydrogen bubbles adhering to the front surface of the conductor were observed moving upward along the groove portion of the conductor. Similarly, also in the hydrogen generating device of Example 2, the hydrogen bubbles adhering to the front surface of the conductor were observed moving upward along the groove portion of the conductor.

In contrast, in the hydrogen generating device of Comparative Example 1, the front surface of the conductor was covered by the hydrogen bubbles in about 10 minutes from the start, and the bubbles adhering to the front surface were observed staying on the front surface of the conductor.

After 10 minutes from the photoirradiation, that is, after the front surface of the conductor had become covered steadily by the generated hydrogen, the amount of the generated hydrogen gas was calculated for each hydrogen generating device, using a gas chromatography. Example 1 showed an amount of 0.34 ml/h (a quantum efficiency of 2.6%), and Comparative Example 1 showed an amount of 0.21 ml/h (a quantum efficiency of 1.7%). The amount of hydrogen gas in Example 1 was 1.62 times that in Comparative Example 1, and exceeded the value of 1.41 times, which was the increment of the front surface area of the conductor. This demonstrated the effect of the present invention to improve the hydrogen production efficiency by providing the groove portion on the conductor. Further, Example 2 showed an amount of 0.30 ml/h (a quantum efficiency of 2.3%), which was 1.43 times that in Comparative Example 1. Thus, the effect of the present invention was demonstrated as well.

When Example 1 and Example 2 are compared to each other, the amount of hydrogen gas was less in Example 2 than in Example 1. However, the co-catalyst functioned efficiently in Example 2, considering that the Pt amount used in Example 2 was considerably less than in Example 1. Thus, it was demonstrated that the configuration of providing the co-catalyst in a part other than the groove portion of the conductor, as in Example 2, allowed the co-catalyst to function efficiently. It can be said from these results that, particularly when hydrogen is generated from the conductor, providing the co-catalyst only in a part of the conductor is advantageous in cost, because co-catalysts having a low overvoltage for hydrogen generation, which are suitable as the co-catalyst, are a noble metal, in general.

### INDUSTRIAL APPLICABILITY

The hydrogen generating device of the present invention exhibits high hydrogen production efficiency by irradiation with light, and can be used as a device for supplying hydrogen to fuel cells. Thus, it also can be used in power production systems for domestic use.

1. A hydrogen generating device comprising:
a housing capable of holding a liquid therein, the housing being at least partially transmissive to light;
an electrolyte held in the housing, the electrolyte containing water;
a photoelectrode arranged in the housing, the photoelectrode having a first surface in contact with the electrolyte, and the photoelectrode generating gas through decomposition of the water by being irradiated with light transmitted through the housing; and
a conductor arranged in a region on a second surface side opposite to the first surface side with respect to the photoelectrode inside the housing, the conductor having a surface in contact with the electrolyte, and the conductor being connected electrically with the photoelectrode, wherein
the conductor has a groove portion provided on the surface in contact with the electrolyte, the groove portion extending along a flow direction of the generated gas.

2. The hydrogen generating device according to claim 1, wherein
the groove portion has a shape linearly extending along the flow direction of the generated gas.

3. The hydrogen generating device according to claim 2, wherein
the conductor has a corrugated shape, and
the groove portion is formed of a valley portion of the corrugated shape.

4. The hydrogen generating device according to claim 1, wherein
the conductor has a plurality of concave portions provided on the surface in contact with the electrolyte, and
the groove portion is formed by the plurality of concave portions being connected to each other.

5. The hydrogen generating device according to claim 1, wherein
the conductor is formed of a metal.

6. The hydrogen generating device according to claim 5, wherein
the conductor is formed of Ti, Ta, Zr, or Al.

7. The hydrogen generating device according to claim 1, wherein
the groove portion has a depth of at least 100 μm but not more than 2 cm.

8. The hydrogen generating device according to claim 1, wherein
a co-catalyst is provided in at least a part of the region other than the groove portion in the conductor.

9. The hydrogen generating device according to claim 8, wherein
the co-catalyst contains at least one selected from Pt, Pd, Rh, Ir, Ru, Os, Au, Ag, Cu, Ni, Fe, Co and Mn.

10. The hydrogen generating device according to claim 1, wherein
the conductor has a projection that is provided in the region other than the groove portion.

11. The hydrogen generating device according to claim 10, wherein
the projection has a co-catalyst provided thereon.

12. The hydrogen generating device according to claim 1, wherein
the groove portion has a hydrophobic coating.
